(19) United States
(12) Patent Application Publication
(10) Pub. No.: US 2020/0208019 A1
(43) Pub. Date: Jul. 2, 2020

(54) CATION-CURABLE RESIN COMPOSITION

(71) Applicant: THREEBOND CO., LTD., Hachioji-shi, Tokyo (JP)

(72) Inventor: Hiroto MATSUOKA, Hachioji-shi, Tokyo (JP)

(21) Appl. No.: 15/779,731

(22) PCT Filed: Nov. 24, 2016
(86) PCT No.: PCT/JP2016/084789

§ 371 Date: May 29, 2018

(30) Foreign Application Priority Data
Dec. 2, 2015 (JP) 2015-235289

(51) Int. Cl. C09J 7/35; C08G 59/24; C08G 59/68; C09J 5/06; C09J 11/06

(52) U.S. Cl. CPC C09J 7/35; C08G 59/245; C08G 59/683; C09J 2463/00; C09J 5/06; C09J 11/06; C09J 2205/102; C08G 59/686

(57) ABSTRACT

An object of the present invention is to provide a cation-curable resin composition having storage stability while maintaining photo-curability and low-temperature curability. Specifically, the present invention provides a cation-curable resin composition including: a component (A): a cation-polymerizable compound; a component (B): a photocationic polymerization initiator; and a component (C): a thermal cationic polymerization initiator containing an amine salt.

### TECHNICAL FIELD

The present invention relates to a cation-curable resin composition having storage stability while maintaining photo-curability and low-temperature (e.g., lower than 100° C.) curability.

### BACKGROUND ART

A cation-polymerizable resin composition containing an epoxy resin or the like has excellent adhesive force, sealing property, strength, heat resistance, electric property, and chemical resistance and thus has been conventionally used in various applications such as an adhesive, an encapsulant, a potting agent, a coating agent, and an electrically-conductive paste. Moreover, the cation-polymerizable resin composition is used for products in various fields and, particularly in electronic devices, is used in semiconductors, flat panel displays such as liquid crystal displays, organic electroluminescence, and touch panels, hard disk devices, mobile terminal devices, camera modules, and the like.

Patent Literature 1 discloses a photo cation polymerizable resin composition containing an epoxy resin and a photocationic initiator which generates a Lewis acid when irradiated with an activation energy beam such as an ultraviolet beam. Moreover, Patent Literature 2 discloses a cation-curable epoxy resin composition containing an epoxy resin component, a photocationic initiator, a thermal cationic initiator, and a filler.

### CITATION LIST

### Patent Literatures

Patent Literature 1: Japanese Patent Application Publication: No. Sho 59-204676

Patent Literature 2: International Patent Application Publication No. WO2005/059002

### SUMMARY OF INVENTION

However, the cation-polymerizable resin composition disclosed in Patent Literature 1 has a problem that a portion where the light does not reach cannot be cured. In order to solve this problem, it is conceivable to achieve curing by heating the cation-polymerizable resin composition to about 200° C. to generate acid from the cationic initiator. However, this method has a problem that, since the curing condition includes very high temperature, it is difficult to apply the cation-polymerizable resin composition to liquid crystal and organic EL elements which tend to be degraded by heat. On the other hand, the cation-curable epoxy resin composition disclosed in Patent Literature 2 has such poor storage stability that it gels in several days at room temperature, because of its use of the photocationic initiator and the thermal cationic initiator.

An object of the present invention is to solve the problems described above, that is, to provide a cation-curable resin composition having storage stability while maintaining photo-curability and low-temperature curability.

The present invention overcomes the conventional problems described above. Specifically, the present invention has the following gist.

A cation-curable resin composition comprising:

a component (A): a cation-polymerizable compound;

a component (B): a photocationic polymerization initiator; and

a component (C): a thermal cationic polymerization initiator containing an amine salt.

Specifically, the present invention may be any of the following modes.

[1]

A cation-curable resin composition comprising:

a component (A): a cation-polymerizable compound;

a component (B): a photocationic polymerization initiator; and

a component (C): a thermal cationic polymerization initiator containing an amine salt.

[2]

The cation-curable resin composition according to [1] wherein the component (C) is a thermal cationic polymerization initiator containing a salt including quaternary ammonium cations.

[3]

The cation-curable resin composition according to [1] or [2] wherein the component (C) is at least one selected from the group consisting of a salt made of quaternary ammonium cations and borate anions, a salt made of quaternary ammonium cations and antimony anions, and a salt made of quaternary ammonium cations and phosphate anions.

[4]

The cation-curable resin composition according to any one of [1] to [3] wherein the component (C) is at least one selected from the group consisting of a salt made of quaternary ammonium cations and borate anions and a salt made of quaternary ammonium cations and antimony anions.

[5]

The cation-curable resin composition according to any one of [1] to [4] wherein the component (A) is at least one selected from the group consisting of epoxy resins, oxetane compounds, and vinyl ether compounds.

[6]

The cation-curable resin composition according to any one of [1] to [5] wherein the cation-curable resin composition contains the component (B) in an amount of 0.1 to 30 parts by mass and the component (C) in an amount of 0.1 to 30 parts by mass, relative to 100 parts by mass of the component (A).

[7]

The cation-curable resin composition according to any one of [1] to [6] wherein the component (B) contains at least one of aromatic iodonium salts and aromatic sulfonium salts.

[8]

The cation-curable resin composition according to any one of [1] to [7] wherein the cation-curable resin composition further comprises a colorant as a component (D).

[9]

A method of bonding adherends comprising:

step 1 of disposing the cation-curable resin composition according to any one of [1] to [8] between paired adherends;

step 2 of irradiating the cation-curable resin composition with an activation energy beam; and

step 3 of heating the cation-curable resin composition at a temperature of 45° C. or higher and lower than 100° C., after the irradiation.

[10]

A cured product formed by curing the cation-curable resin composition according to any one of [1] to [8].

The present invention provides a cation-curable resin composition having storage stability while maintaining photo-curability and low-temperature (for example, lower than 100° C.) curability.

### DESCRIPTION OF EMBODIMENT

The present invention is described below in detail.

### <Cation-Curable Resin Composition>

The present invention relates to a cation-curable resin composition including the following components (A) to (C) and optionally including a component (D) and an additive.

Component (A): cation-polymerizable compound
Component (B): photocationic polymerization initiator
Component (C): thermal cationic polymerization initiator containing amine salt
Component (D): colorant
Substances which satisfy any of the following conditions can be used in any combination, as the components (A) to (D) and the additive of the cation-curable resin composition of the present invention.

### <Component (A)>

The cation-polymerizable compound which is the component (A) of the present invention is a compound in which cross-link reaction is caused by cationic species generated from a cationic polymerization initiator heated or irradiated with an activation energy beam. An epoxy resin, an oxetane compound, a vinyl ether compound, and the like can be used as the component (A) of the present invention, but the component (A) is not particularly limited to these. Among these, the epoxy resin is preferable from the viewpoint that a cured product thereof has excellent characteristics. These substances may be used alone or in a combination of two or more. When two types of cation-polymerizable compounds being the components (A) are to be used, it is appropriate to use the two types of components (A) at a mass ratio of, for example, 10:1 to 1:10, preferably 5:1 to 1:5, more preferably 3:1 to 1:3, even more preferably 2:1 to 1:2, and further preferably 1:1.

Here, the activation energy beam includes an ultraviolet beam, an electron beam, a visible light beam, and the like. It is appropriate that the accumulated light amount of the activation energy beam is, for example, 300 to 100000 mJ/cm², preferably 500 to 50000 mJ/cm², more preferably 1000 to 10000 mJ/cm², even more preferably 2000 to 5000 mJ/cm², and further preferably about 3000 mJ/cm². The wavelength of the activation energy beam is preferably 150 to 830 nm, more preferably 200 to 600 nm, and even more preferably 250 to 380 nm. Moreover, it is appropriate that the heating temperature of the cation-polymerizable compound is, for example, 45° C. or higher and lower than 100° C., more preferably 50° C. or higher and lower than 95° C., even more preferably 55° C. or higher and lower than 90° C., and further preferably 80° C.±5° C.

A substance in a liquid form at 25° C. is preferable as the component (A) because the substance has excellent workability and low-temperature curability. Moreover, the viscosity of the component (A) at 25° C. is preferably 0.1 to 30000 mPa·s, more preferably 1 to 15000 mPa·s, even more preferably 5 to 10000 mPa·s, and further preferably 10 to 1000 mPa·s.

The epoxy resin used as the component (A) includes hydrogenated epoxy resins, alicyclic epoxy resins, aromatic epoxy resins, and the like. Among these, the hydrogenated epoxy resins and the alicyclic epoxy resins are preferable from the viewpoint that these resins have excellent low-temperature curability. Note that the hydrogenated epoxy resins mean compounds and the like obtained by nuclear-hydrogenating aromatic rings in the epoxy resins.

The hydrogenated epoxy resins include hydrogenated bisphenol A epoxy resins, hydrogenated bisphenol F epoxy resins, hydrogenated bisphenol E epoxy resins, diglycidyl ether of an alkylene oxide adduct of hydrogenated bisphenol A, diglycidyl ether of an alkylene oxide adduct of hydrogenated bisphenol F, hydrogenated phenol novolac epoxy resins, hydrogenated cresol novolac epoxy resins, and the like, but are not limited to these. The hydrogenated bisphenol A epoxy resins, the hydrogenated bisphenol F epoxy resins, and the hydrogenated bisphenol E epoxy resins are preferable because these resins have particularly excellent low-temperature curability.

Commercial products of the hydrogenated bisphenol A epoxy resins include YX-8000, YX-8034 (manufactured by Mitsubishi Chemical Corporation), EXA-7015 (manufactured by DIC Corporation), ST-3000 (manufactured by NIPPON STEEL & SUMIKIN CHEMICAL CO., LTD.), RIKARESIN HBE-100 (New Japan Chemical Co., Ltd.), EX-252 (Nagase ChemteX Corporation), and the like. Moreover, commercial products of the hydrogenated bisphenol F epoxy resins include YL-6753 (manufactured by Mitsubishi Chemical Corporation) and the like.

The alicyclic epoxy resins include, for example, 3,4-epoxycyclohexylmethyl (3′,4′-epoxy) cyclohexanecarboxylate, ϵ-caprolactone-modified 3′,4′-epoxycyclohexylmethyl 3,4-epoxycyclohexanecarboxylate, bis (3,4-epoxycyclohexyl)adipate, 1,2-epoxy-4-vinylcyclohexane, 1,4-cyclohexanedimethanol diglycidyl ether, epoxy ethyl divinyl cyclohexane, diepoxy vinylcyclohexene, 1,2,4-triepoxyethylcyclohexane, limonene dioxide, silicone oligomer containing alicyclic epoxy groups, and the like, but are not limited to these.

Commercial products of the alicyclic epoxy resins include CELLOXIDE 2081 (3′,4′-epoxycyclohexylmethyl 3,4-epoxycyclohexanecarboxylate), CELLOXIDE 2021P (3′,4′-epoxycyclohexylmethyl 3,4-epoxycyclohexanecarboxylate), CELLOXIDE 2000 (1,2-epoxy-4-vinylcyclohexane), CELLOXIDE 3000 (1-methyl-4-(2-methyloxiranyl) -7-oxabicyclo [4.1.0] heptane), EHPE 3150 (1,2-epoxy-4-(2-oxiranyl)cyclohexane adduct of 2,2-bis(hydroxymethyl)-1-butanol (manufactured by Daicel Corporation), TTA21 (manufactured by Jiangsu TetraChem Co. Ltd) X-40-2670, X-22-169AS, X-22-169B (Shin-Etsu Chemical Co., Ltd.) and the like, but are not limited to these.

The aromatic epoxy resins include aromatic bisphenol A epoxy resins, aromatic bisphenol F epoxy resins, aromatic bisphenol E epoxy resin, diglycidyl ether of an alkylene oxide adduct of aromatic bisphenol A, diglycidyl ether of an alkylene oxide adduct of aromatic bisphenol F, diglycidyl ether of an alkylene oxide adduct of aromatic bisphenol E, aromatic novolac epoxy resins, urethane-modified aromatic epoxy resins, nitrogen-containing aromatic epoxy resins, rubber-modified aromatic epoxy resins containing rubbers such as polybutadiene or nitrile butadiene rubber (NBR), and the like.

Commercial products of the aromatic epoxy resins include jER825, 827, 828, 828EL, 828US, 828XA, 834, 806, 806H, 807, 604, 630 (manufactured by Mitsubishi Chemical Corporation), EPICLON 830, EXA-830LVP, EXA-850CRP, 835LV, HP4032D, 703, 720, 726, HP820, N-660, N-680, N-695, N-655-EXP-S, N-665-EXP-S, N-685-EXP-S, N-740, N-775, N-865 (manufactured by DIC Corporation), EP4100, EP4000, EP4080, EP4085, EP4088, EP4100HF, EP4901HF, EP4000S, EP4000L, EP4003S, EP4010S, EP4010L (manufactured by ADEKA CORPORATION), DENACOL EX614B, EX411, EX314, EX201, EX212, EX252 (Nagase ChemteX Corporation) and the like, but are not limited to these. These products may be used alone or in a mixture of two or more.

The oxetane compounds include 3-ethyl-3-hydroxymethyloxetane, 3-(meta)allyloxymethyl-3-ethyloxetane, (3-ethyl-3-oxetanylmethoxy)methylbenzene, 4-fluoro-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, 2-ethylhexyl(3-ethyl-3-oxetanylmethyl)ether, ethyldiethyleneglycol(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, ethylene glycol bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, trimethylolpropane tris(3-ethyl-3-oxetanylmethyl)ether, pentaerythritol tris(3-ethyl-3-oxetanylmethyl)ether, pentaerythritol tetrakis(3-ethyl-3-oxetanylmethyl)ether, dipentaerythritol tetrakis (3-ethyl-3-oxetanylmethyl)ether, ditrimethylolpropane tetrakis (3-ethyl-3-oxetanylmethyl)ether, and the like. Commercial products of the oxetane compounds include OXT-212, OXT-221, OXT-213, OXT-101 (manufactured by TOAGOSEI CO., LTD.) and the like.

The vinyl ether compounds include 1,4-butanedioldivinyl ether, diethylene glycol divinyl ether, triethylene glycol divinyl ether, tetraethylene glycol divinyl ether, normal propyl vinyl ether, isopropyl vinyl ether, normal butyl vinyl ether, isobutyl vinyl ether, 2-ethylhexyl vinyl ether, cyclohexyl vinyl ether, 2-hydroxyethyl vinyl ether, diethylene glycol monovinyl ether, 4-hydroxybutyl vinyl ether, 2-(2-vinyloxyethoxy)ethyl acrylate, 2-(2-vinyloxyethoxy)ethyl methacrylate, and the like. Commercial products of the vinyl ether compounds include NPVE, IPVE, NBVE, IBVE, EHVE, CHVE (manufactured by NIPPON CARBIDE INDUSTRIES CO.,INC.), HEVE, DEGV, HBVE (Maruzen Petrochemical Co., Ltd.), VEEA, VEEM (manufactured by NIPPON SHOKUBAI CO., LTD.), and the like.

### <Component (B)>

The component (B) of the present invention is a compound which is a photocationic polymerization initiator and which generates cationic species when irradiated with the activation energy beam. The component (B) includes onium salts such as aromatic iodonium salts and aromatic sulfonium salts but is not particularly limited to these. These may be used alone or in a combination of two or more. The aromatic sulfonium based photocationic polymerization initiators include initiators such as a photocationic polymerization initiator containing sulfonium ions in which all three groups bonded to a sulfur atom are aryl groups. Moreover, the aromatic iodonium based photocationic polymerization initiators include initiators such as a photocationic polymerization initiator containing iodonium ions in which two groups bonded to an iodine atom are aryl groups. When two types of photocationic polymerization initiators being the components (B) are to be used, it is appropriate to use the two types of components (B) at a mass ratio of, for example, 10:1 to 1:10, preferably 5:1 to 1:5, more preferably 3:1 to 1:3, even more preferably 2:1 to 1:2, and further preferably 1:1.

Here, the preferable type of activation energy beam, the preferable accumulated light amount of the activation energy beam, and the preferable wavelength of the activation energy beam are the same as those in the aforementioned description of the component (A).

The aromatic iodonium salts include diphenyliodonium tetrakis(pentafluorophenyl)borate, diphenyliodonium hexafluorophosphate, diphenyliodonium hexafluoroantimonate, di(4-nonylphenyl)iodonium hexafluorophosphate, 4-methylphenyl-4-(1-methylethyl)phenyliodonium tetrakis(pentafluorophenyl)borate, and the like.

Commercial products of the aromatic iodonium salts include IRGACURE-250 (manufactured by BASF SE), PI-2074 (manufactured by Rhodia, 4-methylphenyl-4-(1-methylethyl)phenyliodonium tetrakis(pentafluorophenyl)borate, B2380 (bis(4-tert-butylphenyl)iodoniumhexafluorophosphate), B2381, D2238, D2248, D2253, 10591 (manufactured by Tokyo Chemical Industry Co., Ltd.), WPI-113 (bis[4-n-alkyl(C10-13)phenyl]iodonium hexafluorophosphate), WPI-116 (bis[n-alkyl(C10-13)phenyl]iodonium hexafluoroantimonate), WPI-169, WPI-170 (bis(4-tert-butylphenyl)iodonium hexafluorophosphate), WPI-124 (bis(4-n-alkyl(C10-13)phenyl]iodonium tetrakis fluorophenyl borate) (manufactured by Wako Pure Chemical Corporation), and the like.

The aromatic sulfonium salts include triphenylsulfonium hexafluorophosphate, triphenylsulfonium hexafluoroantimonate, triphenylsulfonium tetrakis(pentafluorophenyl)borate, 4,4′-bis(diphenylsulfonio)diphenylsulfide-bishexafluorophos phate, 4,4′-bis[di(β-hydroxyethoxy)phenylsulfonio]diphenylsulfide-bishexafluoroantimonate, 4,4′-bis[di(β-hydroxyethoxy)phenylsulfonio]diphenylsulfide-bishexafluorophosphate, 7-[di(p-toluoyl)sulfonio]-2-isopropylthioxanthone hexafluoroantimonate, 7-[di(p-toluoyl)sulfonio]-2-isopropylthioxanthone tetrakis(pentafluorophenyl)borate, 4-phenylcarbonyl-4′-diphenylsulfonio-diphenylsulfide-hexafl uorophosphate, 4-(p-ter-butylphenylcarbonyl)-4′-diphenylsulfonio-diphenylsulfide-hexafluoroantimonate, 4-(p-ter-butylphenylcarbonyl)-4′-di(p-toluoyl)sulfonio-diphenylsulfide-tetrakis(pentafluorophenyl)borate, and the like, but are not limited to these. These photocationic polymerization initiators may be used alone or in a mixture.

Commercial products of the aromatic sulfonium salts include SP-150, SP-170, SP-172 (manufactured by ADEKA CORPORATION), CPI-100P, CPI-101A, CPI-110B, CPI-200K, CPI-210S (manufactured by San-Apro Ltd.), T1608, T1609, T2041 (tris(4-methylphenyl)sulfonium hexafluorophosphate), T2042 (tri-p-tolylsulfonium trifluoromethanesulfonate) (manufactured by Tokyo Chemical Industry Co., Ltd.), UVI-6990, UVI-6974 (manufactured by Union Carbide Corporation), DTS-200 (manufactured by Midori Kagaku CO., Ltd.), and the like.

The amount of the component (B) mixed in the cation-curable resin composition of the present invention is not limited to a particular amount. However, the amount of the component (B) mixed is preferably within a range of 0.1 to 30 parts by mass, and more preferably 0.5 to 15 parts by mass, relative to 100 parts by mass of the component (A). Such a range is preferable because sufficient photo-curability can be obtained when the amount of the component (B) mixed is 0.1 parts by mass or more and the component (B) can be sufficiently dissolved in the component (A) when the amount of the component (B) mixed is 30 parts by mass or less.

A cationic polymerization initiator (excluding the component (C)) which can be activated by the activation energy beam and also by heat is handled as the component (B) in the present invention.

### <Component (C)>

The component (C) of the present invention is a compound which is a thermal cationic polymerization initiator containing amine salt and which generates cationic species when heated. The component (C) includes thermal cationic polymerization initiators containing salts including quaternary ammonium cations and the like. More specifically, the component (C) includes a salt made of quaternary ammonium cations and borate anions, a salt made of quaternary ammonium cations and antimony anions, a salt made of quaternary ammonium cations and phosphate anions, and the like. Among these, the salt made of quaternary ammonium cations and borate anions and the salt made of quaternary ammonium cations and antimony anions are preferable because these salts have excellent low-temperature curability. The borate anions include tetrafluoroborate anions, tetrakis(perfluorophenyl)borate anions, and the like. The antimony anions include tetrafluoro antimony anions, tetrakis(perfluorophenyl)antimony anions, and the like. The phosphate anions include hexafluorophosphate anions, trifluoro[tris(perfluoroethyl)], and the like.

Commercial products of the component (C) include CXC-1612 (manufactured by King Industries, Inc., a thermal cationic polymerization initiator containing a salt made of quaternary ammonium cations and borate anions), CXC-1821 (manufactured by King Industries, Inc., a thermal cationic polymerization initiator containing a salt made of quaternary ammonium cations and antimony anions), and the like.

The amount of the component (C) mixed in the cation-curable resin composition of the present invention is not limited to a particular amount. However, it is appropriate that the amount mixed is preferably within a range of 0.1 to 30 parts by mass, and more preferably 0.5 to 15 parts by mass, relative to 100 parts by mass of the component (A). Such a range is preferable because sufficient low-temperature curability can be obtained when the amount of the component (C) mixed is 0.1 parts by mass or more and the storage stability does not decrease when the amount of the component (C) mixed is 30 parts by mass or less.

The mixed amount ratio between the component (B) and the component (C) is, for example, 10:1 to 1:10, preferably 5:1 to 1:5, more preferably 3:1 to 1:3, and even more preferably 3:1 to 3:2 in the mass ratio of component (B):component (C).

### <Component (D)>

The cation-curable resin composition of the present invention may also contain a colorant such as a pigment or a dye as the component (D), as long as the colorant does not impair the characteristics of the present invention. Among these, the pigment is preferable from the viewpoint of durability. Among pigments, black pigments are preferable from the viewpoint of excellent concealment. The black pigments include carbon black, black titanium oxide, copper chrome black, cyanine black, aniline black, and the like. Among these, carbon black is preferable from the viewpoint of concealment and dispersibility in the component (A) of the present invention. The amount of the component (D) mixed in the cation-curable resin composition of the present invention is not limited to a particular amount. However, it is appropriate that the amount mixed is preferably within a range of 0.01 to 30 parts by mass, and more preferably 0.05 to 10 parts by mass, even more preferably 0.1 to 5 parts by mass, relative to 100 parts by mass of the component (A).

### <Additive>

The cation-curable resin composition of the present invention may also contain an appropriate amount of additives such as a sensitizer, a silane coupling agent, a polyol compound, a peroxide, a thiol compound, and a storage stabilizer, as long as the additives do not impair the characteristics of the present invention. Moreover, the cation-curable resin composition of the present invention may contain appropriate amounts of various additives such as: an inorganic filler with an average particle size of 0.001 to 100 μm and of calcium carbonate, magnesium carbonate, titanium oxide, magnesium hydroxide, talc, silica, alumina, glass, aluminum hydroxide, boron nitride, aluminum nitride, magnesium oxide or the like; electrically-conductive particles of silver or the like; a fire retardant; rubber such as acrylic rubber and silicone rubber; a plasticizer; a solvent such as an organic solvent; an antioxidant such as a phenolic antioxidant and a phosphorus antioxidant; a photostabilizer; an UV absorber; a defoamer; a foaming agent; a mold-release agent; a leveling agent; a rheology control agent; a tackifier; a concrete retarder; polymers and thermoplastic elastomers such as polyimide resins, polyamide resins, phenoxy resins, cyanate esters, poly(meth)acrylate resins, polyurethane resins, polyurea resins, polyester resins, polyvinyl butyral resins, SBS, and SEBS. A cation-curable resin composition and a cured product thereof with better resin strength, adhesive strength, fire retardant property, thermal conductivity, workability, and the like can be obtained by adding these additives.

The sensitizer includes 9-fluorenone, anthrone, dibenzosuberone, fluorene, 2-bromofluorene, 9-bromofluorene, 9,9-dimethylfluorene, 2-fluorofluorene, 2-iodofluorene, 2-fluorenamine, 9-fluorenol, 2,7-dibromofluorene, 9-aminofluorene hydrochloride, 2,7-diaminofluorene, 9,9′-spirobi[9H-fluorene], 2-fluorenecarboxaldehyde, 9-fluorenylmethanol, 2-acetylfluorene, benzophenone, diethoxyacetophenone, 2-hydroxy-2-methyl-1-phenylpropan-1-one, benzildimethylketal, 4-(2-hydroxyethoxy)phenyl-(2-hydroxy-2-propyl)ketone, 1-hydroxy-cyclohexyl-phenyl-ketone, 2-methyl-2-morpholino(4-thiomethylphenyl)propane-1-one, 2-benzil-2-dimethylamino-1-(4-morpholinophenyl)butanone, 2-hydroxy-2-methyl-1-[4-(1-methylvinyl)phenyl]propanone oligomer, a nitro compound, a coloring matter, and the like. The amount of the additive to be added is not limited to a particular amount but the absorption wavelength and the molar absorption coefficient need to be taken into account.

The silane coupling agent includes silane coupling agents containing glycidyl groups such as 3-glycidoxypropyltriethoxysilane, 3-glycidoxypropylmethyldimethoxysilane, 3-glycidoxypropyltrimethoxysilane, and 3-glycidoxypropylmethyldiethoxysilane, silane coupling agents containing vinyl groups such as vinyltris(β-methoxyethoxy)silane, vinyltriethoxysilane, and vinyltrimethoxysilane, silane coupling agents containing (meth)acrylic groups such as γ-methacryloxypropyltrimethoxysilane, silane coupling agents containing amino groups such as N-β-(aminoethyl)-γ-aminopropyltrimethoxysilane, γ-aminopropyltriethoxysilane, and N-phenyl-γ-aminopropyltrimethoxysilane, and other silane coupling agents such as γ-mercaptopropyltrimethoxysilane and γ-chloropropyltrimethoxysilane. Among these, the silane coupling agents containing glycidyl groups are preferably used and 3-glycidoxypropyltrimethoxysilane and 3-glycidoxypropyltriethoxysilane are preferable among the silane coupling agents containing glycidyl groups. These agents may be used alone or in a combination of two or more.

The polyol compound may be added to adjust the curing rate and improve the adhesion force. The polyol compound includes aliphatic polyols such as ethylene glycol, propylene glycol, 1,4-butanediol, 1,3-butanediol, 1,9-nonanediol, neopentyl glycol, tricyclodecanedimethylol, cyclohexanedimethylol, trimethylolpropane, glycerin, hydrogenated polybutadiene polyol, and hydrogenated dimer diol, (poly)ether polyols having one or two or more ether bonds such as diethylene glycol, tripropylene glycol, polyethylene glycol, polypropylene glycol, polytetramethylene glycol, trimethylolpropane polyethoxy triol, glycerin polypropoxy triol, bisphenol A polyethoxydiol, bisphenol F polyethoxydiol, and ditrimethylolpropane, polyester polyol compounds, polycaprolactone polyol compounds, polyol compounds having phenolic hydroxy groups, polycarbonate polyols such as polycarbonate diol, and the like.

### <Curing of Cation-Curable Resin Composition>

The cation-curable resin composition of the present invention can be cured when irradiated with the activation energy beam (photo-curability). Moreover, the cation-curable resin composition of the present invention can be cured when heated at a low temperature (low-temperature curability). Furthermore, the cation-curable resin composition of the present invention can be cured when irradiated with the activation energy beam and when heated at a low temperature.

As in the aforementioned description of the component (A), the activation energy beam includes the ultraviolet beam, the electron beam, the visible light beam, and the like. It is appropriate that the accumulated light amount of the activation energy beam is, for example, 300 to 100000 mJ/cm², preferably 500 to 50000 mJ/cm², more preferably 1000 to 10000 mJ/cm², even more preferably 2000 to 5000 mJ/cm², and further preferably about 3000 mJ/cm². The wavelength of the activation energy beam is preferably 150 to 830 nm, more preferably 200 to 600 nm, and even more preferably 250 to 380 nm.

Moreover, “low temperature” described above means that the curable temperature of the cation-curable resin composition of the present invention is low and, in actual, corresponds to a heating condition in a method of curing the cation-curable resin composition of the present invention. Although the heating condition (curable temperature) is not limited to a particular temperature, it is appropriate that the temperature is preferably for example, 45° C. or higher and lower than 100° C., more preferably 50° C. or higher and lower than 95° C., even more preferably 55° C. or higher and lower than 90° C., and further preferably 80° C.±5° C. Moreover, the cation-curable resin composition of the present invention can be cured when irradiated with the activation energy beam. The activation energy beam used in this curing includes the ultraviolet beam, the electron beam, the visible light beam, and the like but is not limited to these. It is appropriate that the accumulated light amount of the activation energy beam is, for example, 300 to 100000 mJ/cm², preferably 500 to 50000 mJ/cm², more preferably 1000 to 10000 mJ/cm², even more preferably 2000 to 5000 mJ/cm², and further preferably about 3000 mJ/cm². The wavelength of the activation energy beam is preferably 150 to 830 nm, more preferably 200 to 400 nm, even more preferably 250 to 350 nm.

### <Bonding Method>

The cation-curable resin composition of the present invention can be also used for bonding of adherends. A specific bonding method includes a method of bonding adherends including step 1 of disposing the cation-curable resin composition of the present invention between paired adherends, step 2 of irradiating the cation-curable resin composition with the activation energy beam, and step 3 of heating the cation-curable resin composition at a temperature of 45° C. or higher and lower than 100° C. after the irradiation. The steps are described below one by one.

### [Step 1]

The cation-curable resin composition of the present invention is disposed between the paired adherends. Specifically, for example, the cation-curable resin composition is disposed by being applied or dripped on one of the adherends and the other adherend is disposed on the thus-disposed cation-curable resin composition. Then, the paired adherends are aligned to be positioned as necessary. For example, a publicly-known application method for a sealing agent and an adhesive can be used for the aforementioned application. For example, methods such as dispensing, spraying, inkjet, screen printing, gravure printing, dipping, and spin coating using an automatic application machine can be used. Glass, plastic, and the like can be used as the adherends and the adherends are preferably flat plate materials which are transparent or translucent and which have a light transmitting property.

### [Step 2]

The disposed cation-curable resin composition is irradiated with the activation energy beam and the curing of the cation-curable resin composition progresses, thereby causing the paired adherends to be temporarily bonded to each other. The curing of the cation-curable resin composition by the irradiation of the activation energy beam proceeds particularly on a surface of the composition and its vicinity. The disposed cation-curable resin composition may be directly irradiated or, particularly when the adherends are transparent or translucent, indirectly irradiated via the adherends. The preferable type of activation energy beam, the preferable accumulated light amount of the activation energy beam, and the preferable wavelength of the activation energy beam are the same as those in the aforementioned description of the component (A).

### [Step 3]

After being irradiated with the activation energy beam, the disposed cation-curable resin composition is heated at a predetermined temperature to be completely cured and the paired adherends are thereby completely bonded (finally bonded) to each other. The curing of the cation-curable resin composition by the heating proceeds inside the composition, that is in a portion other than the surface of the composition and its vicinity. Performing the aforementioned curing reaction by the irradiation in step 2 before the curing reaction by the heating in step 3 causes the curing (cross-link) reaction of the resin composition to start quickly. The curing reaction by the heating in step 3 following step 2 causes the reaction to quickly proceed inside the resin composition where the activation energy beam does not reach, and the resin composition can be completely cured.

It is appropriate that the heating temperature is, for example, 45° C. to 100° C., preferably 45° C. or higher and lower than 100° C., more preferably 50° C. or higher and lower than 95° C., even more preferably 55° C. or higher and lower than 90° C., and further preferably 80° C.±5° C.

### <Applications of Cation-Curable Resin Composition>

Applications of the cation-curable resin composition of the present invention include an adhesive, an encapsulant, a potting agent, a coating agent, an electrically-conductive paste, an adhesive sheet, and the like. Moreover, specific applications of the adhesive, the encapsulant, the potting agent, the coating agent, the electrically-conductive paste, and the adhesive sheet include: an automotive field such as a switch portion, a head lamp, parts inside an engine, an electronic component, a drive engine, and a brake oil tank; a flat panel display field such as a liquid crystal display, organic electroluminescence, a touch panel, a plasma display, and a light-emitting diode display device; a recording field such as a video disc, a CD, a DVD, an MD, a pick-up lens, a hard disk peripheral member, and a blu-ray disc; an electronic material field such as an encapsulation material for an electronic part, an electric circuit, a relay, an electric contact, a semiconductor element, or the like, a die-bonding agent, an electrically-conductive adhesive, an anisotropic electrically-conductive adhesive, and an inter-layer adhesive for multi-layer substrate including a build-up substrate; a camera module such as a CMOS image sensor; a battery field such as an Li battery, a zinc-carbon battery, an alkaline battery, a nickel based battery, a fuel cell, a silicon based solar cell, a dye-sensitized solar cell, and an organic solar cell; an optical parts field such as an optical fiber material in peripheries of an optical switch and an optical connector in an optical communication system, light receiving parts, optical circuit parts, and a periphery of an opto-electronic integrated circuit; a mobile terminal device; an architecture field; an aviation field; and the like. Particularly preferable applications include a CMOS image sensor, an assembly adhesive for a case, a lens, and the like, a sealing agent for a liquid crystal display used to prevent light leakage of a back light, entrance of outside light, and the like.

### EXAMPLES

The present invention is specifically described below by using Examples, but is not limited to the following Examples.

### <Preparation of Cation-Curable Resin Composition>

### Example 1

First, 100 parts by mass of hydrogenated bisphenol A epoxy resin (al) (YX-8000, manufactured by Mitsubishi Chemical Corporation) with a viscosity of 1900 mPa·s at 25° C. as the component (A), 3 parts by mass of 4-methylphenyl-4-(1-methylethyl)phenyliodonium-tetrakis(pen tafluorophenyl)borate (b1) (PI-2074, manufactured by Rhodia) as the component (B), 1 part by mass of a thermal cationic polymerization initiator containing a salt composed of quaternary ammonium cations and borate anions (c1)(CXC-1821, manufactured by King Industries, Inc.) as the component (C) were added, and these components were mixed with a planetary mixer for 60 minutes at normal temperature (25° C.) in the absence of light to obtain Example 1 being a cation-curable resin composition.

### Example 2

Example 2 was prepared in the same manner as in Example 1 except that the amount of the component c1 was changed from 1 part by mass to 2 parts by mass in Example 1.

### Example 3

Example 3 was prepared in the same manner as in Example except that the component a1 was changed to 3′,4′-epoxycyclohexylmethyl 3,4-epoxycyclohexanecarboxylate (a2) (CELLOXIDE 2021P) with a viscosity of 300 mPa·s at 25° C. in Example 1.

### Example 4

Example 4 was prepared in the same manner as in Example 1 except that the amount of the component c1 was changed from 1 part by mass to 2 parts by mass in Example 3.

### Example 5

Example 5 was prepared in the same manner as in Example 1 except that the amount of the component a1 was changed from 100 parts by mass to 50 parts by mass and 50 parts by mass of the a2 component was added in Example 1.

### Example 6

Example 6 was prepared in the same manner as in Example 1 except that the c1 component was changed to a thermal cationic polymerization initiator containing a salt made of quaternary ammonium cations and antimony anions (c2) (CXC-1612, manufactured by King Industries, Inc.) in Example 1.

### Comparative Example 1

Comparative Example 1 was prepared in the same manner as in Example 1 except that the component c1 was changed to a thermal cationic polymerization initiator containing a salt made of aromatic sulfonium cations and borate anions (c′1) (SI-B2A, manufactured by Sanshin Chemical Industry Co.,Ltd.) in Example 1.

### Comparative Example 2

Comparative Example 2 was prepared in the same manner as in Example 1 except that the component c1 was changed to a thermal cationic polymerization initiator containing a salt made of aromatic sulfonium cations and phosphate anions (c′2) (SI-110L, manufactured by Sanshin Chemical Industry Co., Ltd.) in Example 1.

### Comparative Example 3

Comparative Example 3 was prepared in the same manner as in Example 1 except that the component c1 was changed to a thermal cationic polymerization initiator containing a salt made of aromatic sulfonium cations and antimony anions (c′3) (SI-80L, manufactured by Sanshin Chemical Industry Co., Ltd.) in Example 1.

### Comparative Example 4

Comparative Example 4 was prepared in the same manner as in Example 1 except that the component c1 was excluded in Example 1.

### Comparative Example 5

Comparative Example 5 was prepared in the same manner as in Example 1 except that the component b1 was excluded in Example 1.

### <Storage Stability>

The cation-curable resin compositions prepared in Examples and Comparative Examples were put into a plastic container with a volume of 15 ml and left to stand for 30 days in an environment with a temperature of 25° C. Then, a rod with a sharp end was brought into contact with the cation-curable resin compositions to evaluate the cation-curable resin compositions based on the following evaluation criteria.

### [Evaluation Criteria]

OK: No gelling was observed and the composition was observed to be in a liquid form.
NG: Gelling was observed.

### <Photo-Curability Test>

First, 0.01 g of each of the cation-curable resin compositions prepared in Examples and Comparative Examples was dripped and applied on a microscope slide serving as one adherend, and a cover glass serving as another adherend was placed thereon to forma test piece in which the cation-curable resin composition was disposed between the paired glasses as a thin layer. Next, the cation-curable resin composition was irradiated with the activation energy beam by an accumulated light amount of 3000 mJ/cm² by using an ultraviolet irradiation device (manufactured by JATEC, model number: JUL-M-433AN-05, ultraviolet wavelength: 365 nm). Then, a test was performed to check whether the paired glasses were bonded to each other and could not be moved by hand.

### <Low-Temperature Curability Test>

First, 0.1 g of each of the cation-curable resin compositions prepared in Examples and Comparative Examples was dripped on a hot plate set at 80° C. and, after 30 minutes, a rod with a sharp end was brought into contact with the cation-curable resin composition to evaluate whether the composition was cured or not.

TABLE 1

| | Storage | Photo-curability | Low-temperature |
|---|---|---|---|
| | stability | test | curability test |
| Example 1 | OK | Cured | Cured |
| Example 2 | OK | Cured | Cured |
| Example 3 | OK | Cured | Cured |
| Example 4 | OK | Cured | Cured |
| Example 5 | OK | Cured | Cured |
| Example 6 | OK | Cured | Cured |
| Comparative | NG | Cured | Cured |
| Example 1 | | | |
| Comparative | NG | Cured | Uncured |
| Example 2 | | | |
| Comparative | OK | Uncured | Cured |
| Example 3 | | | |
| Comparative | OK | Cured | Uncured |
| Example 4 | | | |
| Comparative | OK | Uncured | Cured |
| Example 5 | | | |

From Examples 1 to 6, it is found that the present invention is excellent in storage stability while maintaining the photo-curability and the low-temperature (lower than 100° C.) curability.

Comparative Example 1 is the composition using the thermal cationic polymerization initiator which contains the salt made of aromatic sulfonium cations and borate anions and which is not the component (C) of the present invention, and is found to have poor storage stability. Moreover, Comparative Example 2 is the composition using the thermal cationic polymerization initiator which contains the salt made of aromatic sulfonium cations and phosphate anions and which is not the component (C) of the present invention, and is found to have poor storage stability and poor low-temperature curability. Furthermore, Comparative Example 3 is the composition using the thermal cationic polymerization initiator which contains the salt made of aromatic sulfonium cations and antimony anions and which is not the component (C) of the present invention, and is found to have poor photo-curability. Moreover, Comparative Example 4 is the composition without the component (C) of the present invention, and is found to have poor low-temperature curability. Furthermore, Comparative Example 5 is the composition without the component (B) of the present invention, and is found to have poor photo-curability.

Next, a test of evaluating the concealment of the cation-curable resin composition of the present invention is performed.

### Example 7

Example 7 was prepared in the same manner as in Example 1 except that, as the component (D), 1 part by mass of carbon black (SRB black T-04, manufactured by MIKUNI COLOR LTD.) being a black pigment was further added in Example 1.

### <Concealment Test>

The cation-curable resin composition of Example 7 was spread to a thickness of 0.2 mm to form a test piece with a smooth surface. The cation-curable resin composition was irradiated with the activation energy by an accumulated light amount of 3000 mJ/cm² by using an ultraviolet irradiation device (manufactured by JATEC, model number: JUL-M-433AN-05, ultraviolet wavelength: 365 nm). Then, the test piece was heated in a thermostat chamber for 30 minutes at 80° C. to obtain a cured product. Then, transmittance of the cured product to green light with a wavelength of 550 nm was measured by using spectrophotometer UV-2450 (manufactured by Shimadzu Corporation). The transmittance was less than 1% and it was confirmed that the cured product had excellent concealment.

### INDUSTRIAL APPLICABILITY

The cation-curable resin composition of the present invention has excellent storage stability while maintaining the photo-curability and the low-temperature (lower than 100° C.) curability. The cation-curable resin composition can be applied in a wide range of fields such as an adhesive, an encapsulant, a potting agent, a coating agent, an electrically-conductive paste, and an adhesive sheet, and is thus industrially useful.

1. A cation-curable resin composition comprising:
a component (A): a cation-polymerizable compound;
a component (B): a photocationic polymerization initiator; and
a component (C): a thermal cationic polymerization initiator containing an amine salt.

2. The cation-curable resin composition according to claim 1 wherein the component (C) is a thermal cationic polymerization initiator containing a salt including quaternary ammonium cations.

3. The cation-curable resin composition according to claim 1 wherein the component (C) is at least one selected from the group consisting of a salt made of quaternary ammonium cations and borate anions, a salt made of quaternary ammonium cations and antimony anions, and a salt made of quaternary ammonium cations and phosphate anions.

4. The cation-curable resin composition according to claim 1 wherein the component (C) is at least one selected from the group consisting of a salt made of quaternary ammonium cations and borate anions and a salt made of quaternary ammonium cations and antimony anions.

5. The cation-curable resin composition according to claim 1 wherein the component (A) is at least one selected from the group consisting of epoxy resins, oxetane compounds, and vinyl ether compounds.

6. The cation-curable resin composition according to claim 1 wherein the cation-curable resin composition contains the component (B) in an amount of 0.1 to 30 parts by mass and the component (C) in an amount of 0.1 to 30 parts by mass, relative to 100 parts by mass of the component (A).

7. The cation-curable resin composition according to claim 1 wherein the component (B) contains at least one of aromatic iodonium salts and aromatic sulfonium salts.

8. The cation-curable resin composition according to claim 1 wherein the cation-curable resin composition further comprises a colorant as a component (D).

9. A method of bonding adherends comprising:
step 1 of disposing the cation-curable resin composition according to claim 1 between paired adherends;
step 2 of irradiating the cation-curable resin composition with an activation energy beam; and
step 3 of heating the cation-curable resin composition at a temperature of 45° C. or higher and lower than 100° C., after the irradiation.

10. A cured product formed by curing the cation-curable resin composition according to claim 1.

11. The cation-curable resin composition according to claim 1 wherein the component (A) is at least one selected from the group consisting of epoxy resins, oxetane compounds, and vinyl ether compounds, wherein the component (B) contains at least one of aromatic iodonium salts and aromatic sulfonium salts, and wherein the component (C) is a thermal cationic polymerization initiator containing a salt including quaternary ammonium cations.

12. The cation-curable resin composition according to claim 1 wherein the component (A) is a bisphenol A epoxy resins, wherein the component (B) contains aromatic iodonium salts, and wherein the component (C) is a thermal cationic polymerization initiator containing a salt made of quaternary ammonium cations and borate anions.

13. The cation-curable resin composition according to claim 11 wherein the cation-curable resin composition contains the component (B) in an amount of 0.1 to 30 parts by mass and the component (C) in an amount of 0.1 to 30 parts by mass, relative to 100 parts by mass of the component (A).

14. The cation-curable resin composition according to claim 12 wherein the cation-curable resin composition contains the component (B) in an amount of 0.1 to 30 parts by mass and the component (C) in an amount of 0.1 to 30 parts by mass, relative to 100 parts by mass of the component (A).

15. An adhesive comprising the cation-curable resin composition according to claim 1.

16. An adhesive comprising the cation-curable resin composition according to claim 11.

17. The adhesive according to claim 15 in the form of a sheet.
